(19) United States
(12) Patent Application Publication
(10) Pub. No.: US 2010/0252599 A1
(43) Pub. Date: Oct. 7, 2010

(54) MANUFACTURING METHOD FOR DISPLAY DEVICE

(75) Inventors: Yasushi Nakano, Tokyo (JP); Susumu Sasaki, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/748,659

(22) Filed: Mar. 29, 2010

(30) Foreign Application Priority Data
Apr. 1, 2009 (JP) 2009-088753

(51) Int. Cl. B26F 3/00

(52) U.S. Cl. 225/2

(57) ABSTRACT

The present invention provides a manufacturing method for a display device according to which an unused portion can be cut out without damaging the surface having an electrode terminal. The manufacturing method is for a display device having at least one display region formed between a first substrate on which an electrode terminal is formed and a second substrate made of a resin, and has the steps of creating a scribe line on the second substrate and pasting a columnar body of revolution of which the round surface is made of an elastic body and adhesive to the outer surface of the second substrate so that the second substrate is bent as the body of revolution rolls over the second substrate, which is thus cut along the scribe line.

### CROSS REFERENCE TO RELATED APPLICATION

The present application claims priority over Japanese Application JP2009-088753 filed on Apr. 1, 2009, the contents of which are hereby incorporated into this application by reference.

### BACKGROUND OF THE INVENTION

(1) Field of the Invention

The present invention relates to a manufacturing method for a display device, and in particular, to a display device using a substrate made of a resin.

(2) Description of the Related Art

Flat display devices, such as liquid crystal display devices, have such a structure that a first substrate on which thin film transistors and the like are formed and a second substrate on which color filters and the like are formed are positioned so as to face each other with liquid crystal in between, and a sealing material fixes the fist substrate and the second substrate together and seals in the liquid crystal. In accordance with the manufacturing method for a liquid crystal display device having such a structure, thin film transistors and electrodes, which are required to form a number a number of display devices, are formed on one of the pair of glass substrates, which are referred to as mother glass (mother substrate), while color filters are formed on the other sheet of mother glass. After that, the two sheets of mother glass are fixed to each other with a sealing material, so that a number of display devices (hereinafter referred to as unit display device) are formed from the pair of mother glass sheets, and then the mother glass sheets are cut into unit display devices, and thus a number of liquid crystal display devices are manufactured in one process.

In this process, as described in JP1994-48755A, for example, first a scribe line is created on the first mother glass substrate, and after being turned over the first substrate is cut along the scribe line. Next, a scribe line is created on the second mother glass substrate, and after being turned over the second substrate is cut along the scribe line. By repeating this process a number of display devices are cut out from the pair of mother glass substrates.

### SUMMARY OF THE INVENTION

Together with the increased performance of liquid crystal display devices in recent years, liquid crystal display devices have come to be used in a broader range of fields, and the performance required for liquid crystal display devices has been increasing year by year, and liquid crystal display devices using lightweight transparent substrates made of a resin having excellent resistance against impact as the first and second substrates are in demand.

Though liquid crystal display devices using transparent substrates made of a resin are excellent in terms of their resistance against impact and more flexible than those using glass substrates, resin substrates cannot be cut, even when bent along a scribe line, unlike glass substrates, and therefore, cutting methods using a laser have been proposed. However, cutting using a laser has a problem, such that the second substrate cannot be cut in parts facing the electrode terminal portion of the first substrate. That is to say, the first substrate and the second substrate are positioned so as to face each other over a distance of approximately 4 μm, and therefore, in the case where an unused portion of the second substrate is cut out using a laser in a liquid crystal display device using a resin substrate of 200 μm, a problem arises, such that the electrode terminal is damaged.

For this reason, the prior art provides a method according to which a trench which becomes a scribe line is created in the portion along which the substrate is to be cut using a laser, a plate-like tool is inserted from the side between the first substrate and the second substrate, and the unused portion is cut out by raising the tool so that only the end portion of the second substrate rises to the side opposite to the first substrate, and there is still a risk that the electrode terminal may be damaged.

The present invention is provided in order to solve these problems, and an object of the present invention is to provide a manufacturing method for a display device according to which it is possible to easily cut out an unused portion without damaging the surface having an electrode terminal.

The gist of a representative invention from among the inventions disclosed in the present specification is simply described as follows.

The present invention provides a manufacturing method for a display device having a first substrate on which an electrode terminal for inputting a control signal from the outside is formed, a second substrate made of a resin which is positioned so as to face the first substrate, and at least one display region formed between the above described first substrate and the above described second substrate, comprising the steps of creating a scribe line on the second substrate; and pasting a columnar body of revolution of which at least the round surface is formed of an elastic body and the round surface is adhesive to the outer surface of the above described second substrate so that the above described second substrate is bent in the direction of rotation as the body of revolution rolls over the second substrate, which is thus cut along the above described scribe line, characterized in that a display panel portion of the above described second substrate where at least one display regions is formed and an unused portion formed so as to extend to the display panel portion are separated from each other.

According to the present invention, an unused portion can be easily cut out without damaging the surface having an electrode terminal.

### BRIEF DESCRIPTION OF THE DRAWINGS

FIG. 1 is a schematic plan diagram showing the structure of a liquid crystal display device manufactured in accordance with the manufacturing method for a display device according to the first embodiment of the present invention;

FIGS. 2A to 2C are diagrams for illustrating the principle for cutting out an unused portion from the second substrate during the manufacturing process for a liquid crystal display device according to the first embodiment of the present invention;

FIGS. 3A to 3D are diagrams for illustrating a method for cutting out an unused portion when a number of display devices are cut out from a pair of mother glass substrates in accordance with the manufacturing method for a liquid crystal display device according to the first embodiment of the present invention;

FIGS. 4A to 4D are top diagrams for illustrating the points along which a number of display devices are cut out from a pair of mother glass substrates and the points where scribe lines are created in accordance with the manufacturing method for a liquid crystal display device according to the first embodiment of the present invention;

FIGS. 5A to 5D are cross sectional diagrams for illustrating the manufacturing method for a liquid crystal display device according to the second embodiment of the present invention; and

FIGS. 6A to 6E are cross sectional diagrams for illustrating the manufacturing method for a liquid crystal display device according to the third embodiment of the present invention.

### DESCRIPTION OF THE PREFERRED EMBODIMENTS

In the following, examples of the embodiments to which the present invention is applied are described in reference to the drawings. Here, in the following description, the same symbols are attached to the same components and the same descriptions are not repeated.

### First Embodiment

### Structure of Liquid Crystal Display Device

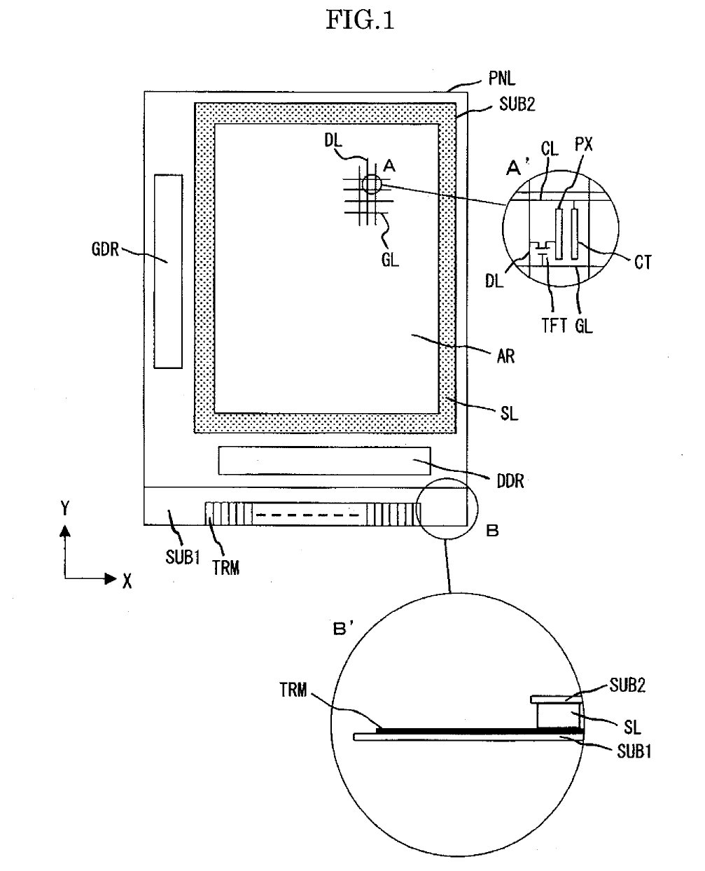

FIG. 1 is a schematic plan diagram showing the structure of a liquid crystal display device manufactured in accordance with the manufacturing method for a display device according to the first embodiment of the present invention. The liquid crystal display device according to the first embodiment in FIG. 1 has a first substrate (substrate on TFT side) SUB1 on which pixel electrodes and color filters (colored layer) are formed, a second substrate (facing substrate) SUB2 that is positioned so as to face the first substrate SUB1 and a liquid crystal display panel PNL formed of liquid crystal, not shown, that is sandwiched between the first substrate SU_{B1} and the second substrate SUB2, and a liquid crystal display device is formed of a combination of the liquid crystal display panel PNL and a backlight unit, not shown, which is a light source. The first substrate SUB1 and the second substrate SUB2 are secured by a sealing material SL formed around the display region AR, and the liquid crystal sandwiched between the two substrates SUB1 and SUB2 is sealed by the sealing material SL in the configuration. Here, in the following description, the liquid crystal display panel PNL is referred to as liquid crystal display device.

The first substrate SUB1 and the second substrate SUB2 can be formed of well-known plastic (resin) substrates, for example. Thus, in the first embodiment plastic (resin) substrates are used, and a lightweight liquid crystal display device having excellent resistance against impact can be provided. In addition, in the liquid crystal display device according to the first embodiment, the region where display pixels (hereinafter referred to as pixels) are formed in the region in which liquid crystal is sealed is the display region AR. Accordingly, the region where no pixels are formed and which does not relate to display even within the region in which liquid crystal is sealed is not part of the display region AR.

Furthermore, in the liquid crystal display device according to the first embodiment, low temperature polysilicon TFT's (LTPS) are used as the thin film transistors TFT, and a video signal driving circuit (drain driver) DDR is formed on the first substrate SUB1 at the top in the drawing, and a scan signal driving circuit (gate driver) GDR is formed on the first substrate SUB1 on the left in the drawing in the structure. Here, in the case where it is not particularly necessary to differentiate between the drain driver DDR and the gate driver GDR in the following description, the two are simply referred to as drive circuit (driver).

As shown in FIG. 1, in the liquid crystal display device according to the first embodiment, scan lines (gate lines) GL which extend in the direction X and are aligned in the direction Y in the figure are formed in the display region AR on the surface of the first substrate SUB1 on the liquid crystal side. In addition, video signal lines (drain lines) DL which extend in the direction Y and are aligned in the direction X in the figure are formed.

The rectangular region surrounded by the drain lines DL and the gate lines GL provides a region where pixels are formed, and as a result, the pixels are aligned in a matrix within the display region AR in the configuration. In addition, red (R), green (G) and blue (B) color filters, not shown, are formed in this pixel region in the configuration. In particular, in the display device according to the first embodiment, unit pixels for color display are formed of R, G and B pixels which are aligned so as to be adjacent to each other in the direction of the X axis, in the direction in which the gate lines GL extend. Here, the structure of the unit pixels for color display is not limited to this. In addition, the second substrate SUB2 has a structure where a black matrix and an orientation film are formed in the direction in which the gate lines GL extend.

In addition, as shown in the diagram A′ showing an enlargement of the circled portion A in FIG. 1, for example, the pixels are provided with a thin film transistor TFT that is turned on by a scan signal from a gate line GL, a pixel electrode PX to which a video signal is supplied from a drain line DL via this thin film transistor TFT when it is turned on, and a common electrode CT that is connected to a common line CL to which a reference signal having a potential that becomes the reference for the potential of a video signal is supplied. There is an electrical field having a component that is parallel to the surface of the first substrate SUB1 between the pixel electrode PX and the common electrode CT, and this electrical field drives liquid crystal molecules. Such liquid crystal display devices are known to be able to provide so-called wide view angle display, and are referred to as IPS type or lateral electrical field type, because of the above described specificity of the application of an electrical field to the liquid crystal. Here, though in the configuration of the common electrode CT in the diagram A′ a reference signal is inputted into the common electrode CT that is formed separately for each pixel via a common signal line CL, the invention is not limited to this structure, and a common electrode CT may be formed in a plane so as to cover a number of pixels, for example.

In the first embodiment, drain lines DL and gate lines GL extend beyond the sealing material SL in the end portions so as to be respectively connected to drain drivers DDR or gate drivers GDR in the configuration. Here, in the first embodiment, drain drivers DDR and gate drivers GDR, which are drivers for a liquid crystal display device, are formed of LTPS's on the first substrate SUB1, as described above, in the configuration.

Meanwhile, signal lines for inputting a control signal into a drain driver DDR and a gate driver GDR from the outside are formed on the first substrate together with the drain drivers DDR and the gate drivers GDR. In addition, the other end of the signal lines is connected to electrode terminals TRM formed on the first substrate on the facing surface side (liquid crystal surface side) in the configuration, so that a control signal from the outside can be inputted into the liquid crystal display device via the electrode terminals TRM. Accordingly, in the first embodiment, the second substrate is shorter than the first substrate on the side where electrode terminals TRM are formed, so that the two's edges do not match. That is to say, the area above the electrode terminals TRM is open in the structure, and a control signal can be inputted into the liquid crystal display device from the outside by connecting a flexible wiring board, not shown, to the electrode terminals TRM using a publicly known anisotropic conductive film.

Here, though the liquid crystal display device according to the first embodiment has such a structure that drain drivers DDR and gate drivers GDR are formed of LTPS's on the first substrate SUB1, the invention is not limited to this. Drain drivers and gate drivers may be formed of a semiconductor device made of a semiconductor chip, for example, so that the semiconductor chip can be mounted on the first substrate SUB1. Alternatively, one side of a semiconductor device formed in accordance with a tape carrier method or a COF (chip on film) method, for example, may be connected to the first substrate SUB1.

<Principle Behind Cutting Out Unused Portion>

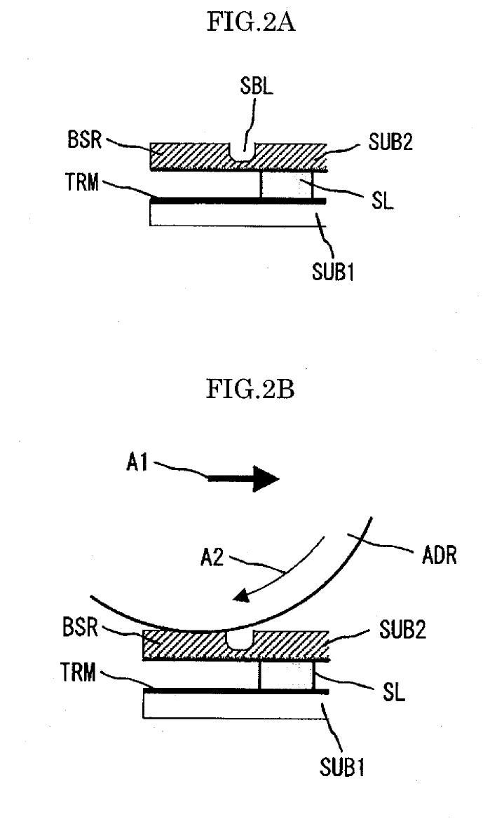

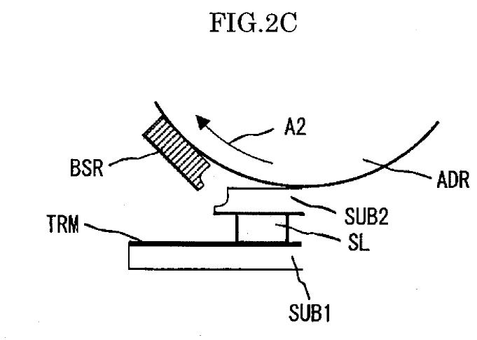

FIGS. 2A to 2C are diagrams for illustrating the principle behind cutting out an unused portion from the second substrate during the manufacturing process for a liquid crystal display device according to the first embodiment of the present invention. First, as shown in FIG. 2A, in order to cut out an unused portion from the second substrate SUB2, a scribe line SBL, which is a trench for cutting, is created between the unused portion BSR and the sealing material SL using a laser, for example. As shown in FIG. 2A, the scribe line SBL at this time is straight in the direction in which the sealing material SL extends. In addition, as concerns the form in a cross section, the trenches on the main surface side (front surface side) of the second substrate and the depth is measured in the direction of the first substrate from the main surface side. In the first embodiment, a scribe line SBL is created by irradiating the main surface side of the second substrate SUB2 with a laser, and therefore, the electrode terminals TRM and the signal lines formed on the surface facing the first substrate SUB1 are not affected. Here, as concerns the direction from which a laser LA is projected, projection from the main surface side of the second substrate SUB2 is efficient, because there are no obstacles, but the laser LA may be projected from the main surface side (bottom side in FIG. 2) of the first substrate SUB1 with the focal point of the laser LA on the main surface side of the second substrate SUB2.

Next, as shown in FIG. 2B, an adhesive roller (body of revolution) ADR in columnar form of which at least the round side has weak adhesiveness is pressed against the second substrate SUB2 on the main surface side, so that the round side of the adhesive roller ADR and the unused portion BSR are pasted together. The rotational axis of the adhesive roller ADR at this time and the direction in which the scribe line SBL created in the second substrate SUB2 extends are in the same direction, and thus, the below described pulling up force and bending force, which work on the unused portion BSR through the scribe line SBL can be maximized, and thus, the unused portion BSR can be cut out and separated from the second substrate SUB2 with less adhesiveness. Alternatively, in the case where the same adhesiveness is used, it becomes possible to minimize the time required for cutting out and separating the unused portion BSR from the second substrate SUB2. Here, in the first embodiment, the second substrate SUB2 and the adhesive roller ADR are held in an appropriate position and moved in the direction indicated by the arrow A1, and at the same time, the adhesive roller ADR is rolled in the direction indicated by the arrow A2, so that the unused portion BSR and the round side of the adhesive roller ADR are pasted together in the configuration.

The adhesive roller ADR is further moved and rotated in such a state that the unused portion BSR and the round side of the adhesive roller ADR are pasted together, so that the left end portion in the figure (open side) of the unused portion BSR is pulled upward toward the main surface side of the second substrate SUB2 as the adhesive roller ADR rotates, and a strong bending force is also applied to the right in the figure as the adhesive roller ADR moves in the direction of the arrow A1. As a result, the unused portion BSR is broken along the scribe line SBL, and as shown in FIG. 2C, only the unused portion BSR is in such a state as to adhere to the adhesive roller ADR and separated from the second substrate SUB2.

As a result, the region of the first substrate SUB1 where electrode terminals TRM are formed protrudes from the second substrate SUB2, and therefore, it is possible to connect a flexible substrate, not shown, to the electrode terminals TRM.

Here, though in the above description, the adhesive roller ADR moves in the direction of the arrow A1 in the configuration, the invention is not limited to this. For example, the first substrate SUB1 and the second substrate SUB2, which are secured by means of a sealing material SL, may move in the direction opposite to the arrow A1 in the configuration, and this case is the same as that where the adhesive roller ADR moves in the direction of the arrow A1. Furthermore, the first substrate SUB1 and the second substrate SUB2 may move in the direction opposite to the arrow A1 and the adhesive roller ADR move in the direction of the arrow A1 in the configuration.

<Number of Devices Cut Out from a Pair of Mother Glass Substrates>

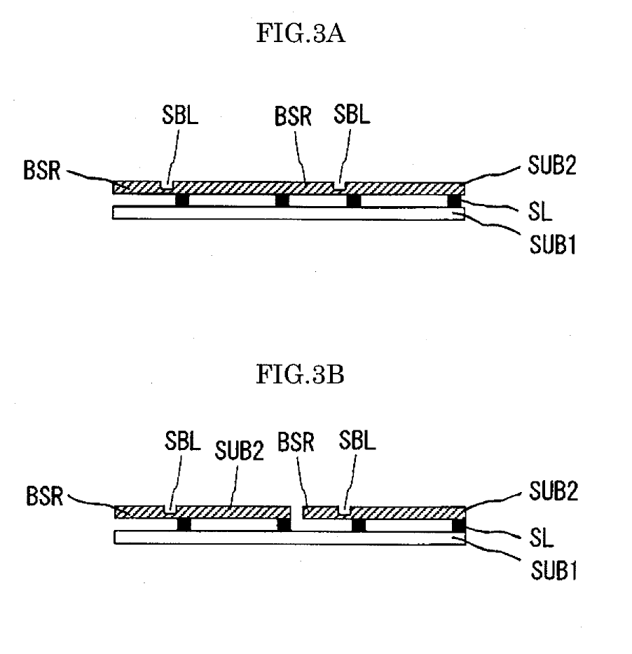

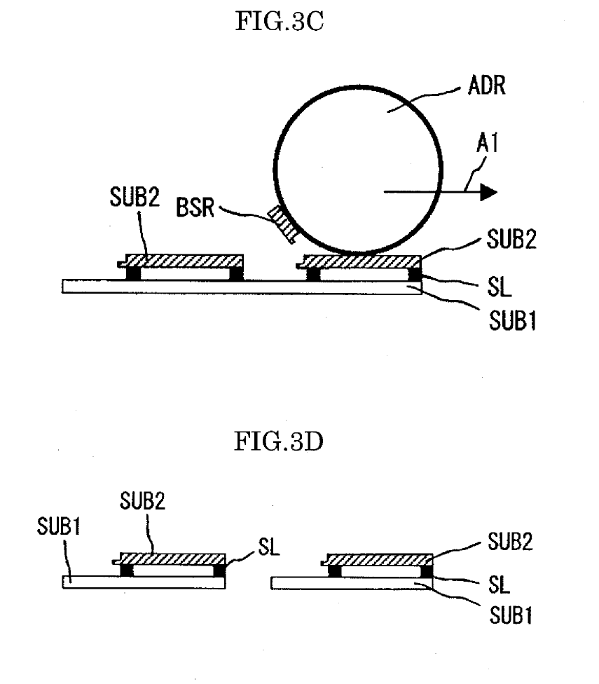

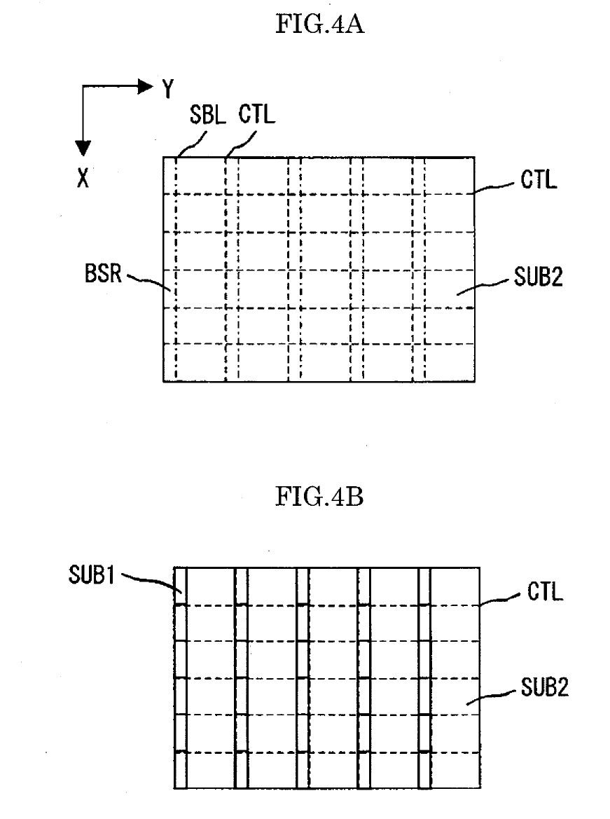

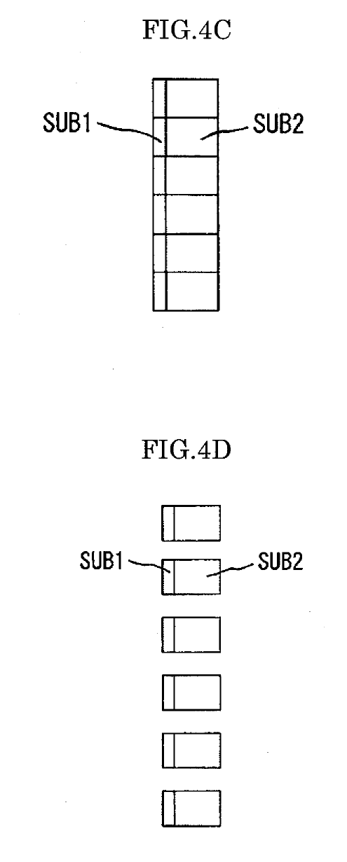

FIGS. 3A to 3D are diagrams for illustrating a method for cutting out an unused portion when a number of devices are cut out from a pair of mother glass substrates in accordance with the manufacturing method for a liquid crystal display device according to the first embodiment of the present invention, and FIGS. 4A to 4D are top diagrams for illustrating where a number of devices are cut out and scribe lines are created in accordance with the manufacturing method for a liquid crystal display device according to the first embodiment of the present invention. Here, in FIGS. 4A to 4D, simple dotted lines indicate where the devices are cut by means of a laser, single-dot chain lines indicate where scribe lines are created by means of a laser, and solid lines indicate where the devices are cut. In addition, in order to make the description simpler, one mother substrate (mother resin substrate) is divided into thirty pieces: five in the lateral direction and six in the longitudinal direction in the figures, in accordance with the manufacturing method for a liquid crystal display device according to the first embodiment, but the number of pieces is not limited to this. Furthermore, X and Y in the figures indicate the X axis and the Y axis, respectively, and correspond to the X axis and the Y axis in FIG. 1, respectively.

In accordance with the manufacturing method for a liquid crystal display device according to the first embodiment, a method for forming a mother substrate on the first substrate SUB1 side and a mother substrate on the second substrate SUB2 side and the step of securing these together are used in the same process as in the process for a conventional liquid crystal display device made of a resin. Accordingly, in the following description, a process for forming a liquid crystal display device, which is a unit display device having a display region from one mother substrate, is described in detail in reference to FIGS. 3A to 4D.

As shown in FIG. 4A, in the first embodiment the mother substrate is divided in six in the longitudinal direction (direction of X axis) and in five in the lateral direction (direction of Y axis), so that 30 liquid crystal display devices are formed from the one mother substrate. In the first embodiment, trenches to become scribe lines are created where scribe lines SBL are shown in FIG. 4A. FIG. 3A shows the state of the mother substrate at this time, and first a trench that is to become a scribe line SBL is created between the unused portion BSR of the second substrate SUB2 and the sealing material SL, and thus it is easy to cut out the unused portion BSR.

Next, the mother substrate is irradiated with a laser along cutting lines CTL indicated by dotted lines in FIG. 4A so that only the second substrate SUB2 is divided into unit display devices. FIG. 3B is a diagram showing an enlargement of the first substrate SUB1 and the second substrate SUB2 in a cross section at this time, and as is clear from this FIG. 3B, the unused portion BSR is supported by the second substrate SUB2 only in the portion along which the scribe line SBL is created in the configuration. Here, the first substrate SUB1 and the second substrate SUB2 are secured together with a sealing material SL in the configuration, and therefore, the mother substrate is not divided into unit display devices.

Next, as shown in FIG. 3C, the adhesive roller ADR moves and rolls in the direction of the arrow A1, so that the point of adhesion of the adhesive roller ADR continuously shifts from the unused portion BSR side of the unit display device toward the display region side. When the adhesive roller ADR moves and rotates, unused portion BSR is cut along the scribe line SBL and separated from the second substrate SUB2 as the adhesive roller ADR rotates. FIG. 4B shows the state of the mother substrate at this time, and the unused portion BSR is cut and separated from the second substrate SUB2 along the line indicated by the solid line.

After that, the first substrate SUB1 is first cut along the cutting lines CTL in the direction of the X axis in FIG. 4A by means of a laser, so that five mother substrates along which six unit display devices are aligned in the direction of the X axis in FIG. 4C are formed. Next, the five mother substrates are cut along the cutting lines CTL in the direction of the Y axis, so that liquid crystal display devices are gained as divided unit display devices, as shown in FIGS. 4D and 3D. At this time, as shown in FIG. 3D, each liquid crystal display device formed collectively together with other devices is in such a form that the region of the first substrate SUB1 where an electrode terminal TRM is formed protrudes from the second substrate SUB2, thus making it possible to connect a flexible substrate, not shown, to the electrode terminal TRM.

As described above, in accordance with the manufacturing method for a liquid crystal display device according to the present first embodiment, a scribe line that is to become a cutting line is created in a region between an unused portion of the second substrate and the sealing material, and after that a cylindrical body of revolution of which the round side is formed of an elastic body and adhesive is pasted to the outer surface (main surface) of the second substrate, and the unused portion formed so as to continue the second substrate, is bent in the direction of the body of revolution as the body of revolution rotates so as to be cut along the scribe line in the configuration, and therefore, the unused portion is easy to cut out without damaging the surface on which an electrode terminal is provided.

### Second Embodiment

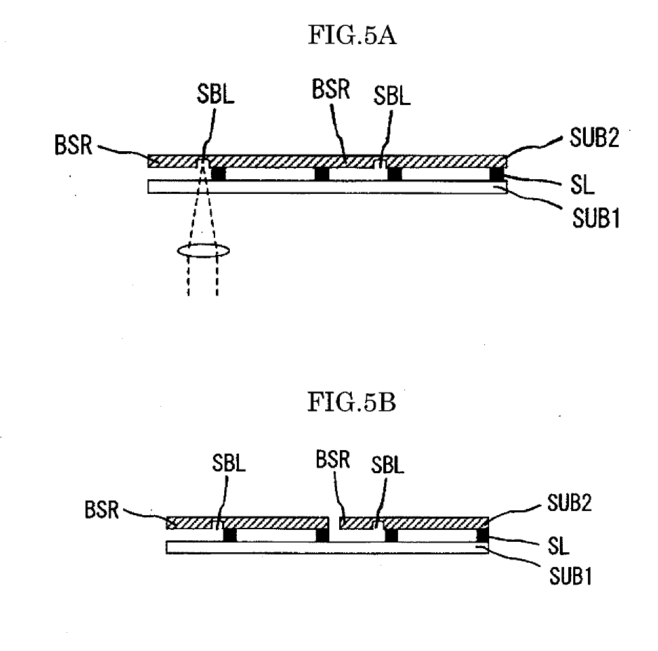

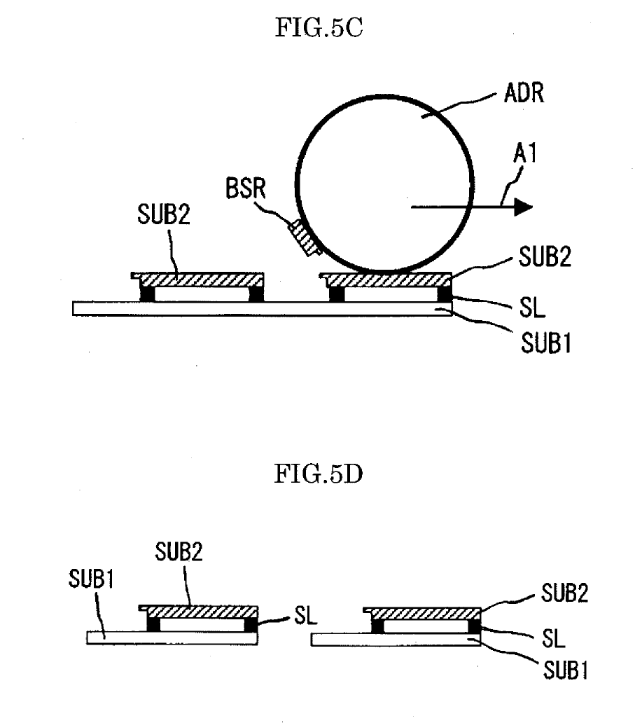

FIGS. 5A to 5D are cross sectional diagrams for illustrating the manufacturing method for a liquid crystal display device according to the second embodiment of the present invention. The manufacturing method for a liquid crystal display device according to the second embodiment is the same as in the first embodiment, except that the scribe line is created in a different place on the second substrate SUB2. Accordingly, in the following description, the method for creating a scribe line and where it is created are described in detail. Here, in the following description, a number of unit display devices are formed from one mother substrate, and the first substrate SUB1 and the second substrate SUB2 are secured to each other using a sealing material SL, and after that the mother substrate is cut into a number of display devices, and thus the number of display devices are manufactured.

As shown in FIG. 5A, in the second embodiment a laser LA is projected from the side facing the second substrate SUB2, that is to say, the main surface side of the first substrate SUB1, so that a scribe line SBL that is a trench on the side facing the second substrate SUB2 is created in the mother substrate of the second substrate SUB2. At this time, the scribe line SBL is created on the side facing the second substrate SUB2, and it is merely half-cut; that is, a trench that is to become a scribe line SBL is created in the second substrate SUB2, and therefore, the laser output is relatively low in comparison with in the case of cutting, and the electrode terminal, not shown, and the signal line are not affected as the scribe line SBL is created. In addition, in the second embodiment, the laser LA is condensed so that the focal point falls beneath the center of the second surface SUB2 in the direction of the thickness, so that a scribe line SBL is created as a trench on the side facing the second substrate SUB2. Furthermore, in the second embodiment, a laser LA is projected from the rear surface side of the mother substrate, that is to say, from the first substrate SUB1 side in the configuration, and therefore, it is possible to place the laser device for creating a scribe line SBL within the main body of a liquid crystal manufacturing apparatus, and thus such special effects that the space above the liquid crystal manufacturing apparatus can be used for other applications can be gained. Here, the point that is irradiated with the laser beam LA is not limited to being on the first substrate SUB1 side, and the laser beam may be projected from the main surface side of the second substrate SUB2, as in the first embodiment, and when such a configuration is provided, it is possible to use the laser beam LA efficiently.

Next, as shown in FIG. 5B, the second substrate SUB2 is cut along a cutting line, not shown, by means of a laser that is projected from the first substrate SUB1 side. When the second substrate SUB2 is cut in this fashion, the unused portion BSR of the second substrate SUB2 is supported by the second substrate SUB2 only in the portion along which the scribe line SBL is created in the configuration. Here, the first substrate SUB1 and the second substrate SUB2 are secured to each other through a sealing material SL in the configuration, and therefore, the mother substrate is not divided into unit display devices after this cutting step.

Next, as shown in FIG. 5C, the adhesive roller ADR continuously moves and rotates from the unused portion BSR side to the display region side (direction of arrow A1 in the figure), and as a result the unused portion BSR is cut along the scribe line SBL and separated from the second substrate SUB2 as the adhesive roller ADR rotates.

After that, the first substrate SUB1 is cut along the cutting lines, not shown, by means of a laser, so that a number of liquid crystal display devices (thirty) that are divided as unit display devices are formed, and thus, the same effects as in the first embodiment can be gained.

### Third Embodiment

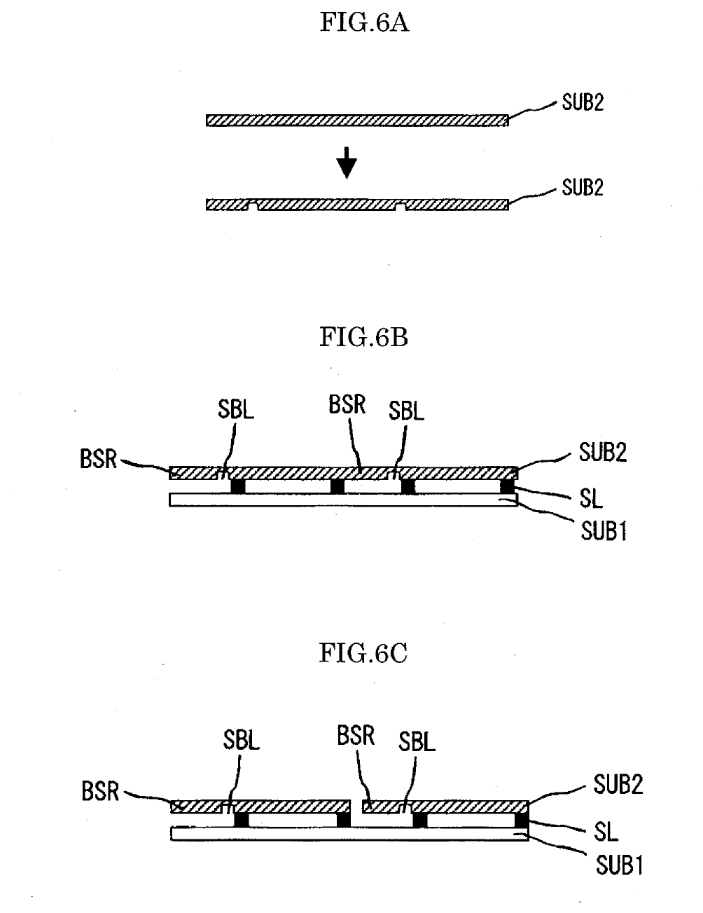

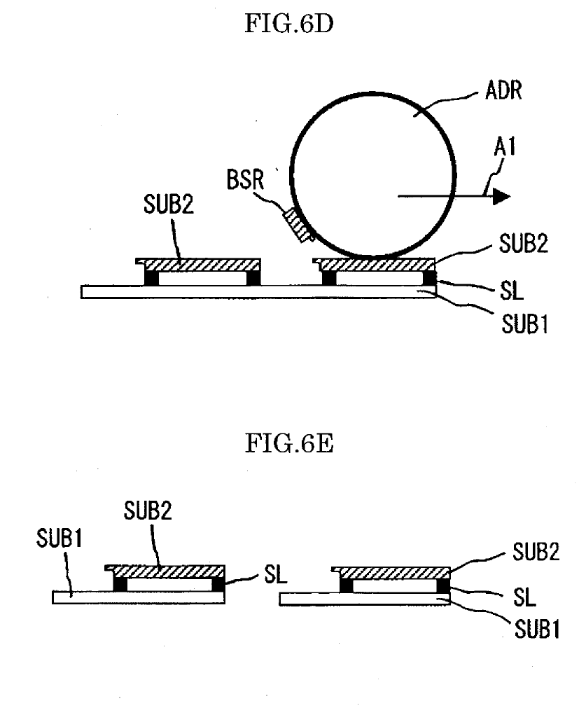

FIGS. 6A to 6E are cross sectional diagrams for illustrating the manufacturing method for a liquid crystal display device according to the third embodiment of the present invention. The manufacturing method for a liquid crystal display device according to the third embodiment is the same as in the second embodiment, except that the scribe line is created on the inner side of the second substrate SUB2 before the first substrate SUB1 and the second substrate SUB2 are secured to each other with a sealing material SL. Accordingly, the method for creating the scribe line is described in detail below. Here, in the following description, a number of unit display devices are formed from one mother substrate, and the first substrate SUB1 and the second substrate SUB2 are secured to each other using a sealing material SL, and after that the mother substrate is cut into a number of display devices, and thus the number of display devices are manufactured.

A shown in FIG. 6A, in the third embodiment a scribe line SBL is created on the second substrate SUB2 through laser half cutting before the second substrate SUB2 is secured to the first substrate SUB1.

Next, as shown in FIG. 6B, the first substrate SUB1 and the second substrate SUB2 are secured to each other with a sealing material SL, and after that, as shown in FIG. 6C, the second substrate SUB2 is cut along a cutting line, not shown, using a laser. When the second substrate SUB2 is cut in this fashion, the unused portion BSR of the second substrate SUB2 is supported by the second substrate SUB2 only in the portion along which the scribe line SBL is created in the configuration, as in the second embodiment.

Next, as shown in FIG. 6D, the adhesive roller ADR continuously moves and rolls from the unused portion BSR side to the display region side (direction of arrow A1 in the figure), so that the unused portion BSR is cut along the scribe line SBL and separated from the second substrate SUB2 as the adhesive roller ADR rotates. After the unused portion BSR is separated, the first substrate SUB1 is cut along a cutting line, not shown, by means of a laser, so that liquid crystal display devices are formed as divided unit display devices, and therefore, the same effects as in the first and second embodiments can be gained.

Particularly, the third embodiment has such a configuration that a scribe line SBL is created on the inner side of the second substrate SUB2 before the first substrate SUB1 and the second substrate SUB2 are secured to each other, and therefore, such special effects that a scribe line SBL can be created efficiently can be gained.

Here, though the first to third embodiments describe a case where the manufacturing method for a display device according to the present invention is applied to the manufacture of a liquid crystal display device, the invention is not limited to the manufacture of a liquid crystal display device, and it is possible to apply it to the manufacture of other flat display devices using a resin substrate, for example display devices using organic light emitting diodes (OLED's) and organic EL display devices.

Though in the above the invention made by the present inventor is concretely described on the basis of embodiments of the invention, the present invention is not limited to the above described embodiments, and can, of course, be modified within such a scope as not to depart from the gist of the invention.

What is claimed is:

1. A manufacturing method for a display device having a first substrate on which an electrode terminal which inputs a control signal from an outside is formed, a second substrate made of a resin which is positioned so as to face the first substrate, and at least one display region formed between said first substrate and said second substrate, comprising the steps of:
creating a scribe line on the second substrate; and
pasting a columnar body of revolution of which at least a round surface is formed of an elastic body and the round surface is adhesive to an outer surface of said second substrate so that said second substrate is bent in a direction of rotation as the body of revolution rolls over the second substrate, which is thus cut along said scribe line, characterized in that
a display panel portion of said second substrate where at least one display regions is formed and an unused portion formed so as to extend to the display panel portion are separated from each other.

2. The manufacturing method for a display device according to claim 1, characterized in that
a point at which said body of revolution and said second substrate are pasted together shifts from said unused portion to said display region.

3. The manufacturing method for a display device according to claim 1, characterized in that
said scribe line is a trench on the outer surface of said second substrate.

4. The manufacturing method for a display device according to claim 1, characterized in that
said scribe line is a trench on an inner surface of said second substrate.

5. The manufacturing method for a display device according to claim 1, characterized in that
said scribe line is created by means of a laser.

6. The manufacturing method for a display device according to claim 5, characterized in that
said laser is projected from an outside.

7. The manufacturing method for a display device according to claim 5, characterized in that
said laser is projected from the first substrate side.

8. The manufacturing method for a display device according to claim 1, characterized in that
an adhesion of said body of revolution is enough to hold a cut portion until the cut portion is separated but weaker than an adhesion of a sealing material for pasting said first substrate and second substrate together.

9. The manufacturing method for a display device according to claim 1, characterized in that
the step of creating the scribe line on the second substrate is carried out before pasting said first substrate and said second substrate together with said sealing material.
